(19) United States
(12) Patent Application Publication
(10) Pub. No.: US 2026/0316921 A1
(43) Pub. Date: Oct. 15, 2026

(54) FLEXIBLE COMPOSITE LAMINATE SKIN

(71) Applicant: Lockheed Martin Corporation, Bethesda, MD (US)

(72) Inventors: Dustin Eli Gamble, San Luis Obispo, CA (US); Terrance James Elliott Storey, San Luis Obispo, CA (US); Gavin Paul Abel, Santa Maria, CA (US); Alan H. Dressel, Palmdale, CA (US)

(73) Assignee: Lockheed Martin Corporation, Bethesda, MD (US)

(21) Appl. No.: 19/178,375

(22) Filed: Apr. 14, 2025

(51) Int. Cl. B64C 1/00; B32B 5/18; B32B 5/24; B32B 7/12; B64C 3/20; B64C 5/02; B64F 5/10; B64U 20/65

(52) U.S. Cl. CPC B64C 1/00; B32B 5/18; B32B 5/245; B32B 7/12; B64C 3/20; B64F 5/10; B64U 20/65; B32B 2262/0269; B32B 2266/0228; B32B 2605/18; B64C 2001/0072; B64C 5/02

(57) ABSTRACT

A method of fabricating a component of an aircraft includes placing a dry composite sheet onto a flat surface. The method further includes applying a resin to the dry composite sheet. The method further includes vacuum curing the resin and the dry composite sheet to form a flexible composite laminate sheet. The method further includes applying an adhesive to the flexible composite laminate sheet to form an adhesive-backed flexible composite skin. The method further includes applying the adhesive-backed flexible composite skin to a core in order to form the component of the aircraft.

### TECHNICAL FIELD

This disclosure generally relates to skin for vehicles such as aircraft, and more specifically to flexible composite laminate skin.

### BACKGROUND

Vehicles such as aircraft typically have various components that are required to be both lightweight and strong. For example, unmanned aerial vehicles (UAVs) are typically powered by electric engines with limited thrust and power storage capabilities. As a result, components of the UAV such as the wings, fuselage, and vertical surfaces need to have a high strength to weight ratio. Typical processes for generating vehicle components that have high strength to weight ratios, however, are time consuming and are not adaptable to changes required by rapid design and production processes.

### SUMMARY

In some embodiments, an aircraft includes a plurality of components. Each component includes a core and an adhesive-backed flexible composite skin coupled to the core. The adhesive-backed flexible composite skin includes a flexible composite laminate sheet formed by vacuuming curing a dry composite sheet on a flat surface. The adhesive-backed flexible composite skin further includes an adhesive coupled to the flexible composite laminate sheet.

In some embodiments, a method of fabricating a component of an aircraft includes placing a dry composite sheet onto a flat surface. The method further includes applying a resin to the dry composite sheet. The method further includes vacuum curing the resin and the dry composite sheet to form a flexible composite laminate sheet. The method further includes applying an adhesive to the flexible composite laminate sheet to form an adhesive-backed flexible composite skin. The method further includes applying the adhesive-backed flexible composite skin to a core in order to form the component of the aircraft.

In some embodiments, a method of fabricating a wing of an aircraft includes forming a plurality of adhesive-backed flexible composite skins that include a top skin, a bottom skin, a leading-edge skin, and a trailing-edge skin. The method further includes applying the trailing-edge skin to a trailing edge of the wing. The method further includes after applying the trailing-edge skin to the trailing edge of the wing: applying the top skin to a top side of the wing such that the top skin overlaps the trailing-edge skin; and applying the bottom skin to a bottom side of the wing such that the bottom skin overlaps the trailing-edge skin. The method further includes, after applying the top skin and the bottom skin to the wing, applying the leading-edge skin to a leading edge of the wing such that the leading-edge skin overlaps both of the top skin and the bottom skin.

Technical advantages of certain embodiments may include providing methods of fabricating components such as wings of an aircraft that are quick, efficient, and effective at providing the needed high strength-to-weight ratios of many aircraft such as UAVs. For example, some embodiments of the disclosure provide methods of fabricating a wing of an aircraft using an adhesive-backed flexible composite skin. The disclosed embodiments also provide for vehicles such as UAVs that utilize components formed using adhesive-backed flexible composite skin. The flexible composite laminate skin of the disclosed embodiments is easy and quick to form and remains flexible when being applied to a core such as the foam core of a UAV wing. This may enable rapid design and production processes for components such as UAV wings that would otherwise be impossible with current processes that require long cure times for composite laminates.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present disclosure and its advantages, reference is now made to the following descriptions taken in conjunction with the accompanying drawings, in which:

FIG. 1 is a diagram illustrating a vehicle having components formed using a flexible composite laminate skin, according to particular embodiments.

FIG. 2 is a diagram illustrating an adhesive-backed flexible skin being used to form a structural component of the aircraft of FIG. 1, according to particular embodiments.

FIG. 3 is a chart illustrating a method for fabricating a component of an aircraft, according to particular embodiments.

FIG. 4 is a diagram illustrating a method of fabricating a wing of an aircraft, according to particular embodiments.

FIG. 5 is a diagram illustrating the fiber orientation of a skin coupled to a wing of an aircraft, according to particular embodiments.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

Vehicles such as aircraft typically have various components that are required to be both lightweight and strong. For example, unmanned aerial vehicles (UAVs) are typically powered by electric engines with limited thrust and power storage capabilities. As a result, components of the UAV such as the wings, fuselage, and vertical surfaces need to have a high strength to weight ratio. Typical processes for generating vehicle components that have high strength to weight ratios, however, are time consuming and are not adaptable to changes required by rapid design and production processes.

To address these and other problems with fabricating components and structures such as UAV wings that need have a high strength to weight ratio, the disclosed embodiments provide methods for fabricating components using a flexible composite laminate skin. For example, some embodiments of the disclosure provide methods of fabricating a wing of an aircraft using an adhesive-backed flexible composite skin. The disclosed embodiments also provide for vehicles such as UAVs that utilize components formed using adhesive-backed flexible composite skin. The flexible composite laminate skin of the disclosed embodiments is easy and quick to form and remains flexible when being applied to a core such as the foam core of a UAV wing. This may enable rapid design and production processes for components such as UAV wings that would otherwise be impossible with current processes that require long cure times for composite laminates.

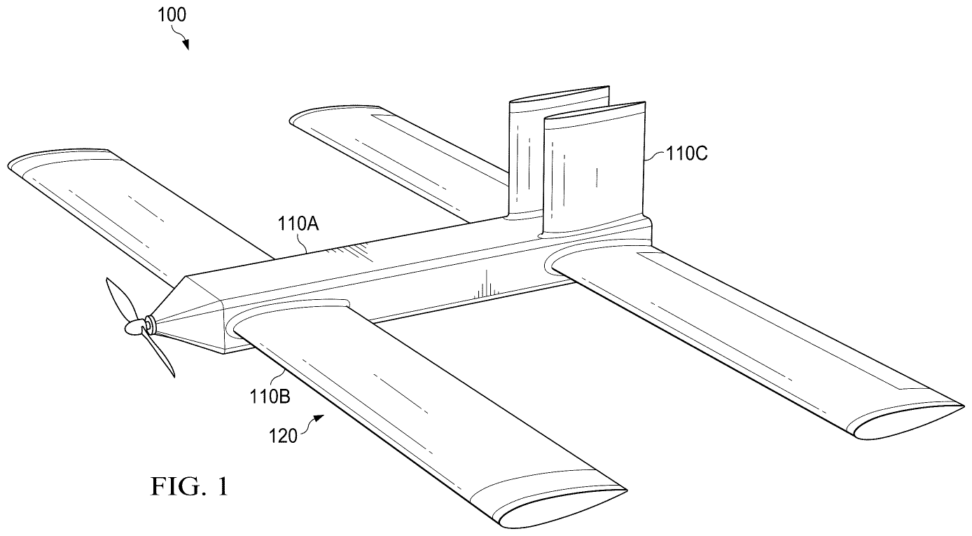

FIG. 1 is a diagram illustrating a vehicle 100 having components 110 (e.g., 110A-110C) formed using a flexible composite laminate skin 120, according to particular embodiments. While vehicle 100 has been illustrated in FIG. 1 as an aircraft (e.g., a UAV), it should be understood that vehicle 100 may be any other appropriate vehicle. For example, vehicle 100 may be an automobile, a boat, and the like.

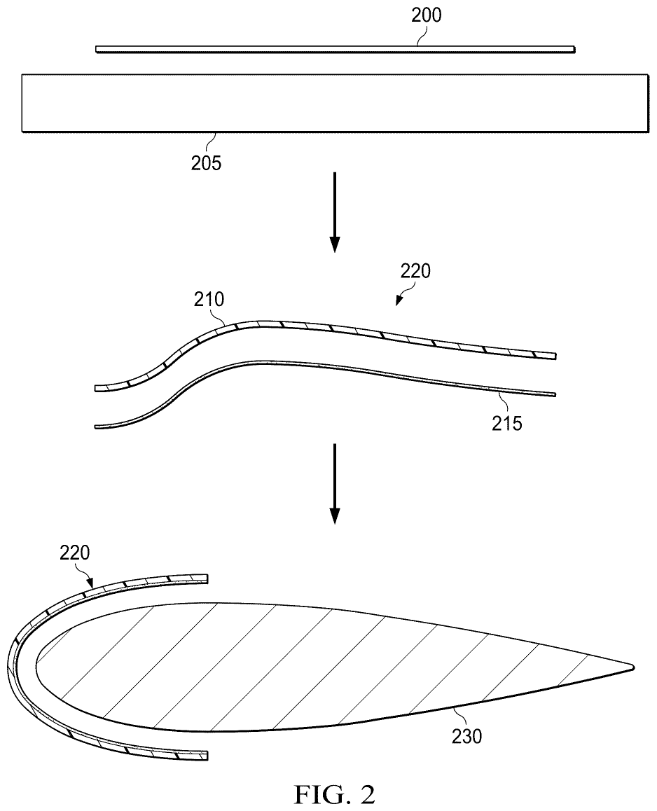

Component 100 may be any portion of vehicle 100 that is desired to have a high strength-to-weigh ratio. For example, components 110 may include one or more of a fuselage 110A, a wing 110B, a vertical tail 110C, and the like. Each component 110 may consist of a core material (e.g., Styrofoam) that is partially or fully covered by flexible composite laminate skin 120. In general, flexible composite laminate skin 120 provides strength (e.g., rigidity) and impact protection for component 110. Rather than being cured into a pre-formed rigid shape to match the shape of component 110 like in traditional processes, however, flexible composite laminate skin 120 remains flexible during the fabrication process of a component 110 such as wing 110B. This allows flexible composite laminate skin 120 to be easily and quickly applied and formed to the contours of a component 110 such as wing 110B, thereby reducing the amount of time required to fabricate vehicle 100. Example embodiments of flexible composite laminate skin 120 are discussed below in reference to FIG. 2.

FIG. 2 is a diagram illustrating an adhesive-backed flexible composite skin 220 that may be used as flexible composite laminate skin 120 to form one or more components 110 of aircraft 100 of FIG. 1, according to particular embodiments. In general, adhesive-backed flexible composite skin 220 is a thin, bendable sheet of composite material that is applied to and formed around a surface of a core 230 in order to form a component 110 such as wing 110B of aircraft 100. Certain embodiments of adhesive-backed flexible composite skin 220 may be formed using the processes below.

In some embodiments, a dry composite sheet 200 is first placed onto a flat release surface 205. In some embodiments, dry composite sheet 200 is cut into a desired shape before being placed onto flat release surface 205. In some embodiments, dry composite sheet 200 is a single-ply of composite material. In other embodiments, dry composite sheet 200 has more that 1-ply of composite material (e.g., 2-ply, 3-ply, etc.) but remains thin enough to still be flexible after curing. In some embodiments, dry composite sheet 200 is made of any appropriate fibers (e.g., carbon fibers, glass, aramid, and the like). In some embodiments, dry composite sheet 200 is a Kevlar sheet.

In some embodiments, flat release surface 205 contains a material or substance that permits dry composite sheet 200 to be easily removed from flat release surface 205 after curing. For example, any non-stick material or item may first be applied to flat release surface 205 and then dry composite sheet 200 may be applied to the non-stick surface.

After dry composite sheet 200 has been placed onto flat release surface 205, any appropriate resin (e.g., epoxy, polyester, etc.) or binding agent is applied to dry composite sheet 200 in order to stiffen dry composite sheet 200. In some embodiments, any appropriate amount of resin or binding agent is applied to dry composite sheet 200 in order for flexible composite laminate sheet 210 to remain flexible.

After the resin or binding agent has been applied to dry composite sheet 200, dry composite sheet 200 and its applied resin or binding agent may be vacuum-cured on flat release surface 205. In some embodiments, this process includes using a vacuum bag and a vacuum pump in order to secure dry composite sheet 200 to flat release surface 205 and hold it flat during the curing process. Once dry composite sheet 200 has been vacuum-cured, the cured composite sheet is removed from flat release surface 205 and is known as flexible composite laminate sheet 210.

After dry composite sheet 200 has been cured into flexible composite laminate sheet 210, an adhesive 215 is applied to one side of flexible composite laminate sheet 210. In some embodiments, adhesive 215 is any pressure-sensitive adhesive. In some embodiments, adhesive 215 is double-side tape such as Very High Bond (VHB) tape or 300LSE tape by 3M. Once adhesive 215 has been applied to flexible composite laminate sheet 210, the resulting product is known as adhesive-backed flexible composite skin 220.

Once adhesive-backed flexible composite skin 220 has been formed using the process above, adhesive-backed flexible composite skin 220 may be applied to core 230 using the applied adhesive 215. In general, core 230 may be a light-weight material that has been cut or otherwise formed into a desired shape. For example, core 230 may be in the shape of wing 110B of a UAV. In some embodiments, core 230 is formed from a foam (e.g., Styrofoam). In some embodiments, adhesive-backed flexible composite skin 220 may be cut into any appropriate shape before being applied to core 230. In addition, any appropriate paint may be applied to adhesive-backed flexible composite skin 220 either before or after being applied to core 230.

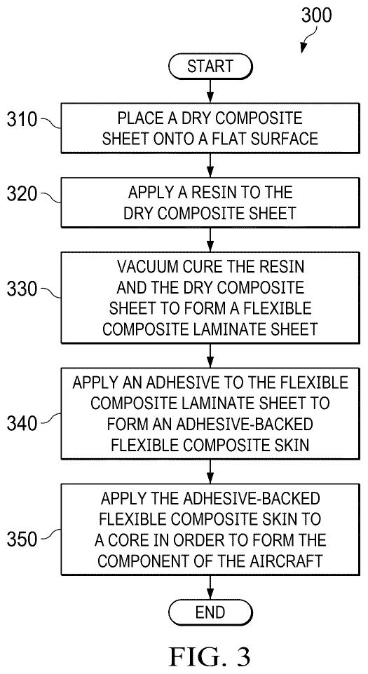

FIG. 3 is a chart illustrating a method 300 for fabricating a component of an aircraft, according to particular embodiments. In some embodiments, method 300 may be used to fabricate a component 110 of vehicle 100 such as wing 110B. At step 310, a dry composite sheet is placed onto a flat surface. In some embodiments, the dry composite sheet is dry composite sheet 200. In some embodiments, the flat surface is flat release surface 205.

At step 320, a resin is applied to the dry composite sheet. In some embodiments, the resin is epoxy, polyester, or any other appropriate resin. In some embodiments, any other binding agent is applied to the dry composite sheet in order to stiffen dry composite sheet (but not cause the dry composite sheet to become completely stiff). In some embodiments, any appropriate amount of resin or binding agent is applied to the dry composite sheet in order for the resulting flexible composite laminate sheet to remain flexible after curing.

At step 330, the resin and the dry composite sheet are vacuum cured to form a flexible composite laminate sheet. In some embodiments, the flexible composite laminate sheet is flexible composite laminate sheet 210. In some embodiments, the dry composite sheet and the resin are vacuum-cured using a vacuum bag and a vacuum pump that holds the dry composite sheet and the resin flat against the flat release surface during curing. Once the flexible composite laminate sheet has been formed in step 330, the flexible composite laminate sheet may be removed from the flat release surface.

At step 340, an adhesive is applied to one side of the flexible composite laminate sheet of step 330 in order to form an adhesive-backed flexible composite skin. In some embodiments, the adhesive-backed flexible composite skin is adhesive-backed flexible composite skin 220. In some embodiments, the adhesive is adhesive 215. In some embodiments, the adhesive is any pressure-sensitive adhesive such as a double-sided tape.

At step 350, the adhesive-backed flexible composite skin formed in step 340 is applied to a core in order to form the component of the aircraft. In some embodiments, the core is core 230. In some embodiments, the core is made of foam (e.g., Styrofoam). After step 350, method 300 may end.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method including the particular steps of the method of FIG. 3, this disclosure contemplates any suitable method including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

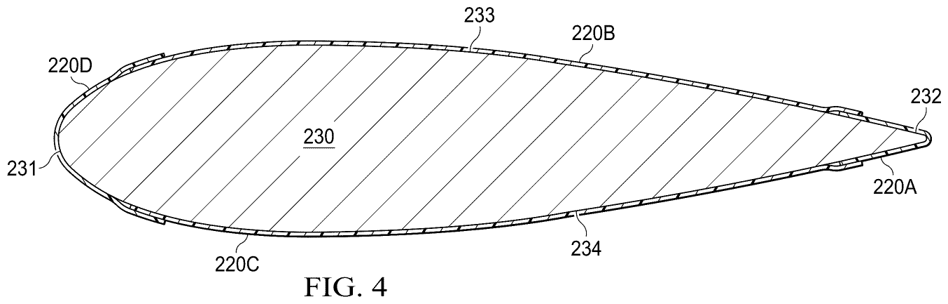

FIG. 4 is a diagram illustrating a method of fabricating a wing of an aircraft using multiple adhesive-backed flexible composite skins 220, according to particular embodiments. In general, using a single adhesive-backed flexible composite skin 220 to form the entire skin of certain components 110 may present issues in certain situations. For example, wrapping a single adhesive-backed flexible composite skin 220 around curves of wing 110B may result in creases, folds, or humps in adhesive-backed flexible composite skin 220. To alleviate these and other problems, multiple adhesive-backed flexible composite skins 220 may be used to cover component 110. In the illustrated example of FIG. 4, for example, four pieces of adhesive-backed flexible composite skin 220 are used to cover core 230 in order to form wing 110B: a trailing-edge skin 220A, a top skin 220B, a bottom skin 220C, and a leading-edge skin 220D. Trailing-edge skin 220A is applied to a trailing edge 232 of wing 110B, top skin 220B is applied to a top side 233 of wing 110B, bottom skin 220C is applied to a bottom side 234 of wing 110B, and leading-edge skin 220D is applied to a leading edge 231 of wing 110B.

In some embodiments, the arrangement illustrated in FIG. 4 is accomplished by first applying trailing-edge skin 220A to trailing edge 232 of wing 110B as illustrated. In some embodiments, trailing-edge skin 220A is formed by cutting an elongated strip from adhesive-backed flexible composite skin 220 and then applying the strip of adhesive-backed flexible composite skin 220 along trailing edge 232 such that the strip extends at least partially onto top side 233 and bottom side 234, as illustrated. Next, top skin 220B and bottom skin 220C are applied to core 230. Top skin 220B is applied to top side 233 such that top skin 220B overlaps at least a portion of trailing-edge skin 232 as illustrated. Similarly, bottom skin 220C is applied to bottom side 234 such that bottom skin 220C overlaps at least a portion of trailing-edge skin 232 as illustrated. Finally, leading-edge skin 220D is applied to leading edge 231 after top skin 220B and bottom skin 220C have been applied such that leading-edge skin 220D overlaps portions of both of top skin 220B and bottom skin 220C as illustrated. In some embodiments, leading-edge skin 220D is formed by cutting an elongated strip from adhesive-backed flexible composite skin 220 and then applying the strip of adhesive-backed flexible composite skin 220 along leading edge 231 such that the strip extends at least partially onto top side 233 and bottom side 234, as illustrated.

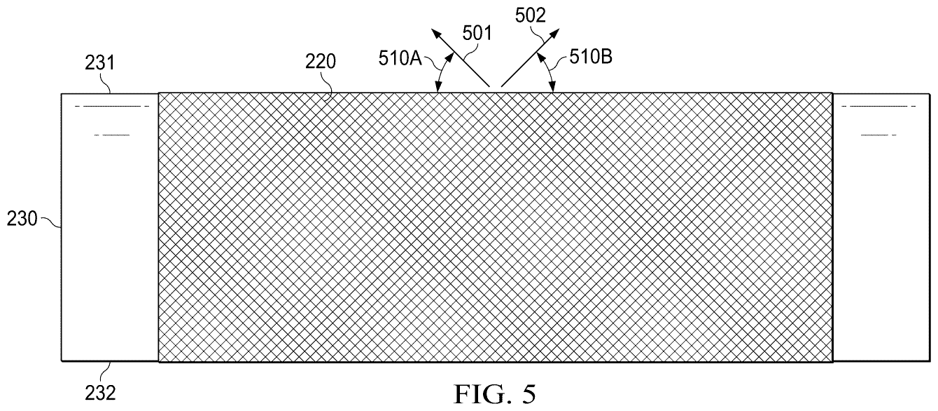

In some embodiments, as illustrated in FIG. 5, top skin 220B and bottom skin 220C are applied to core 230 such that their fiber orientations optimize the rigidity of wing 110B. For example, top skin 220B may be applied to top side 233 of wing 110B such that a fiber orientation of top skin 220B is at an acute angle (e.g., 45 degrees plus or minus five degrees) to at least one of leading edge 231 and trailing edge 232. Similarly, bottom skin 220C may be applied to bottom side 234 of wing 110B such that a fiber orientation of bottom skin 220C is at an acute angle (e.g., 45 degrees plus or minus five degrees) to at least one of leading edge 231 and trailing edge 232. For example, as illustrated in FIG. 5, some embodiments of adhesive-backed flexible composite skin 220 contain fibers that are aligned either along a first axis 501 or a second axis 502, wherein first axis 501 is orthogonal to second axis 502. Fibers within adhesive-backed flexible composite skin 220 that are aligned along first axis 501 are at an acute angle 510A to leading edge 231, and fibers within adhesive-backed flexible composite skin 220 that are aligned along second axis 502 are at an acute angle 510B to leading edge 231. As a result, the rigidity of wing 110B may be increased.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “member,” “module,” “device,” “unit,” “component,” “element,” “mechanism,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

While the include figures illustrate particular embodiments having particular components, this disclosure contemplates other embodiments having some or all of the described components, as well as additional components not described. Components of the present disclosure may be any suitable shape and may be in any suitable configuration.

As used in this document, “each” refers to each member of a set or each member of a subset of a set. Furthermore, as used in the document “or” is not necessarily exclusive and, unless expressly indicated otherwise, can be inclusive in certain embodiments and can be understood to mean “and/or.” Similarly, as used in this document “and” is not necessarily inclusive and, unless expressly indicated otherwise, can be inclusive in certain embodiments and can be understood to mean “and/or.”

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. An aircraft comprising a plurality of components, each component comprising:
a core; and
an adhesive-backed flexible composite skin coupled to the core, the adhesive-backed flexible composite skin comprising:
a flexible composite laminate sheet formed by vacuuming curing a dry composite sheet on a flat surface; and
an adhesive coupled to the flexible composite laminate sheet.

2. The aircraft of claim 1, wherein the plurality of components comprises:
a wing;
a fuselage; and
a vertical tail.

3. The aircraft of claim 1, wherein the core is a foam core.

4. The aircraft of claim 1, wherein the dry composite sheet is a single-ply composite sheet.

5. The aircraft of claim 1, wherein the dry composite sheet is an aramid fiber sheet.

6. The aircraft of claim 1, wherein the adhesive is double-sided tape.

7. The aircraft of claim 1, wherein the aircraft is an unmanned electric aircraft.

8. A method of fabricating a component of an aircraft, the method comprising:
placing a dry composite sheet onto a flat surface;
applying a resin to the dry composite sheet;
vacuum curing the resin and the dry composite sheet to form a flexible composite laminate sheet;
applying an adhesive to the flexible composite laminate sheet to form an adhesive-backed flexible composite skin; and
applying the adhesive-backed flexible composite skin to a core in order to form the component of the aircraft.

9. The method of claim 8, wherein the component of the aircraft is:
a wing;
a fuselage; or
a vertical tail.

10. The method of claim 8, wherein the core is a foam core.

11. The method of claim 8, wherein the dry composite sheet is a single-ply composite sheet.

12. The method of claim 8, wherein the dry composite sheet is an aramid fiber sheet.

13. The method of claim 8, wherein the adhesive is double-sided tape.

14. The method of claim 8, wherein the aircraft is an unmanned electric aircraft.

15. A method of fabricating a wing of an aircraft, the method comprising:
forming a plurality of adhesive-backed flexible composite skins comprising a top skin, a bottom skin, a leading-edge skin, and a trailing-edge skin;
applying the trailing-edge skin to a trailing edge of the wing;
after applying the trailing-edge skin to the trailing edge of the wing:
applying the top skin to a top side of the wing such that the top skin overlaps the trailing-edge skin; and
applying the bottom skin to a bottom side of the wing such that the bottom skin overlaps the trailing-edge skin; and
after applying the top skin and the bottom skin to the wing, applying the leading-edge skin to a leading edge of the wing such that the leading-edge skin overlaps both of the top skin and the bottom skin.

16. The method of claim 15, wherein forming each of the plurality of adhesive-backed flexible composite skins comprises:
placing a dry composite sheet onto a flat surface;
applying a resin to the dry composite sheet;
vacuum curing the resin and the dry composite sheet to form a flexible composite laminate sheet;
applying an adhesive to the flexible composite laminate sheet to form an adhesive-backed flexible composite skin; and
applying the adhesive-backed flexible composite skin to a core in order to form the component of the aircraft.

17. The method of claim 16, wherein the core is a foam core.

18. The method of claim 16, wherein the dry composite sheet is a single-ply aramid fiber sheet.

19. The method of claim 16, wherein the adhesive is double-sided tape.

20. The method of claim 15, wherein the top skin is applied to the top side of the wing such that a fiber orientation of the top skin is at an acute angle to at least one of the leading edge and the trailing edge of the wing.
